(19) United States
(12) Patent Application Publication
(10) Pub. No.: US 2026/0148885 A1
(43) Pub. Date: May 28, 2026

(54) TRANSFORMER CORE

(71) Applicant: ASIAN POWER DEVICES INC., Taoyuan City (TW)

(72) Inventor: Tsung-Liang HUNG, Taoyuan City (TW)

(73) Assignee: ASIAN POWER DEVICES INC., Taoyuan City (TW)

(21) Appl. No.: 19/015,067

(22) Filed: Jan. 9, 2025

(30) Foreign Application Priority Data
Nov. 27, 2024 (TW) 113145892

(51) Int. Cl. H01F 3/14

(52) U.S. Cl. CPC H01F 3/14

(57) ABSTRACT

A transformer core includes a first core component, a second core component, and a plurality of separation components. The first core component includes two first side columns and one first center column. The second core component includes two second side columns and one second center column. The two second side columns are connected with the two first side columns in a non-contact manner, and the second center column is connected with the first center column in a non-contact manner. The separation components are respectively disposed between the two second side columns and the two first side columns, and between the second center column and the first center column so as to block induced current paths between the first core component and the second core component.

### BACKGROUND

### Technical Field

The present disclosure relates to a transformer core, and more particularly to a transformer core with insulation blocking of induced current.

### Description of Related Art

The statements in this section merely provide background information related to the present disclosure and do not necessarily constitute prior art.

Please refer to FIG. 1 and FIG. 2, which show a schematic perspective diagram of a core structure of a traditional transformer and a schematic diagram of a capacitive effect of the transformer core in FIG. 1 respectively. For the transformer core structure of the isolated DC-to-DC power supply, as shown in FIG. 1, it has at least an input side winding coil and an output side winding coil. The input side winding coil is connected to a high-frequency voltage source, and therefore it has a lot of high-frequency noise, and the output side is required to generate a stable and low-noise output voltage as the design goal.

However, the transformer core is not an insulator, but has a high impedance of a certain value. Furthermore, the winding coil is a metal wire and has voltage changes, so the winding coil forms a physical capacitor effect on the iron core, and as the voltage of the winding coil changes, charging and discharging currents and charging and discharging charges are generated. Similarly, the output side winding coil will also form an equivalent capacitance. Since the transformer core is integrated, the charging and discharging currents and charging and discharging charges from the high-noise source winding will be induced to the low-noise source winding (output side) through capacitive coupling.

Therefore, how to design a transformer core, and more particularly to a transformer core with insulation blocking of induced current to solve the problems and technical bottlenecks in the existing technology has become a critical topic in this field.

### SUMMARY

An objective of the present disclosure is to provide a transformer core. The transformer core includes a first core component, a second core component, and a plurality of separation components. The first core component includes two first side columns and one first center column. The second core component includes two second side columns and one second center column. The two second side columns of the second core component are connected with the two first side columns of the first core component in a non-contact manner, and the second center column of the second core component is connected with the first center column of the first core component in a non-contact manner. The separation components respectively disposed between the two second side columns and the two first side columns, and between the second center column and the first center column so as to block induced current paths between the first core component and the second core component.

In one embodiment, each separation component is made of electrically insulating material.

In one embodiment, each separation component is insulating plastic, insulating tape, insulating paint, or paper.

In one embodiment, each separation component is air.

In one embodiment, the first core component and the second core component are an E-shaped magnetic core and an E-shaped magnetic core respectively.

Another objective of the present disclosure is to provide a transformer core. The transformer core includes a first core component, a second core component, and a plurality of separation components. The first core component includes two first side columns and one first center column. The second core component includes two side terminals and one center terminal. The two side terminals of the second core component are connected with the two first side columns of the first core component in a non-contact manner, and the center terminal of the second core component is connected with the first center column of the first core component in a non-contact manner. The separation components respectively disposed between the two second side columns and the two first side columns, and between the second center column and the first center column so as to block induced current paths between the first core component and the second core component.

In one embodiment, each separation component is made of electrically insulating material.

In one embodiment, each separation component is insulating plastic, insulating tape, insulating paint, or paper.

In one embodiment, each separation component is air.

In one embodiment, the first core component and the second core component are an E-shaped magnetic core and an I-shaped magnetic core respectively.

Accordingly, the present disclosure has the following features: the transformer core is physically divided into at least two parts, and contact surfaces of the magnetic bodies in each divided magnetic body are electrically insulated to ensure that the divided magnetic bodies do not directly contact each other so as to block currents flowing through induced current paths. Furthermore, the present disclosure has the following advantages: 1. the conductor losses caused by induced current, and the common mode current can be reduced; 2. as the common mode noise in the transformer core is reduced, the use of external EMI filters can be reduced, and due to its small size, it contributes to high efficiency and miniaturization design; 3. it does not increase or change the performance or quantity of core raw materials, and therefore it can significantly increase performance within a limited cost.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic perspective diagram of a core structure of a traditional transformer.

FIG. 2 is a schematic diagram of a capacitive effect of the transformer core in FIG. 1.

FIG. 3 is a schematic perspective diagram of a transformer core according to a first embodiment of the present disclosure.

FIG. 4 is a schematic diagram of blocking induced current paths of the transformer core in FIG. 3.

FIG. 5 is a schematic perspective diagram of the transformer core according to a second embodiment of the present disclosure.

FIG. 6 is a schematic diagram of blocking induced current paths of the transformer core in FIG. 5.

FIG. 7 is a waveform diagram of actual verification results of the traditional transformer core.

FIG. 8 is a waveform diagram of actual verification results of the transformer core according to the present disclosure.

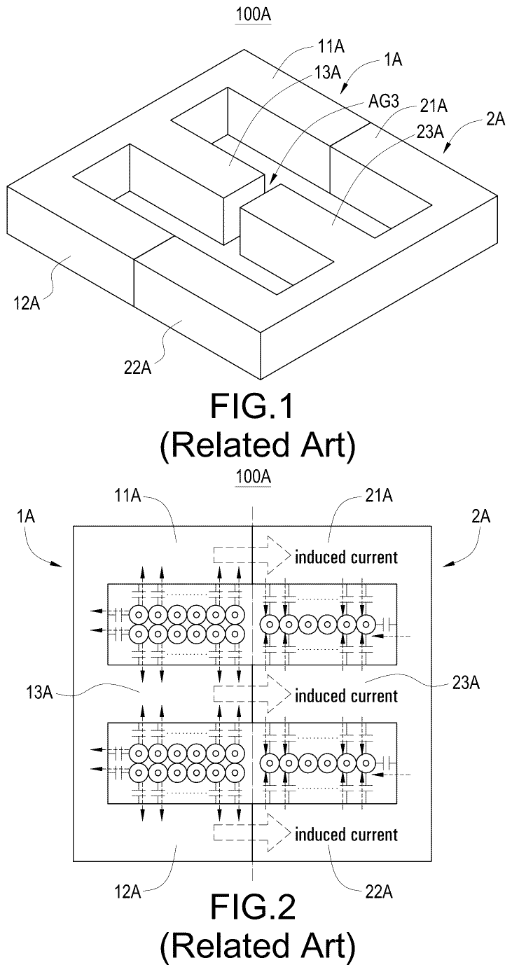

### DETAILED DESCRIPTION

Reference will now be made to the drawing figures to describe the present disclosure in detail. It will be understood that the drawing figures and exemplified embodiments of present disclosure are not limited to the details thereof.

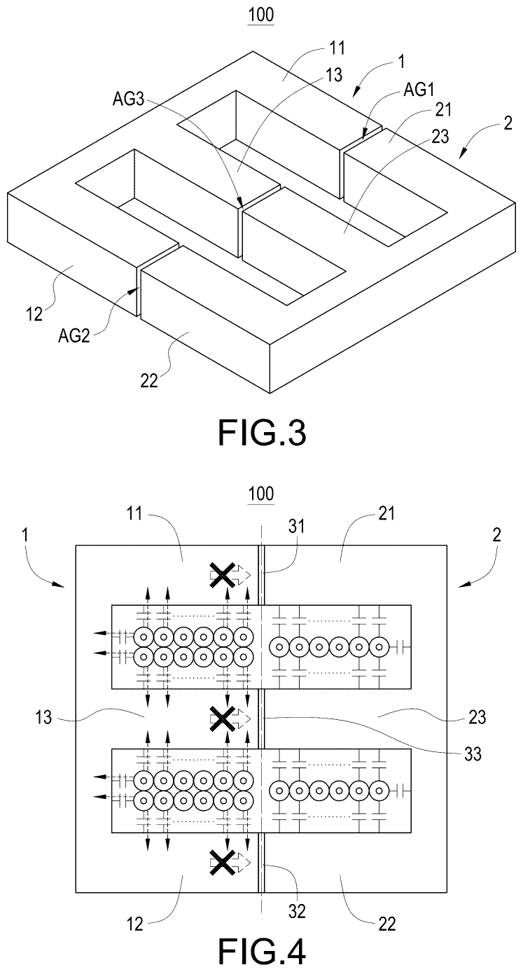

Please refer to FIG. 3 and FIG. 4, which show a schematic perspective diagram of a transformer core according to a first embodiment of the present disclosure and a schematic diagram of blocking induced current paths of the transformer core in FIG. 3 respectively. The transformer core 100 includes a first core component 1, a second core component 2, and a plurality of separation components 31,32,33. In this embodiment, the first core component 1 and the second core component 2 are an E-shaped magnetic core and an E-shaped magnetic core respectively, that is the transformer core 100 is an EE-type core.

The first core component 1 includes two first side columns 11,12 and one first center column 13. The second core component 2 includes two second side columns 21,22 and one second center column 23. The two second side columns 21,22 of the second core component 2 are connected with the two first side columns 11,12 of the first core component 1 in a non-contact manner. Specifically, the second side column 21 is connected with the first side column 11 in a non-contact manner, and a first air gap AG1 is formed between the second side column 21 and the first side column 11. The second side column 22 is connected with the first side column 12 in a non-contact manner, and a second air gap AG2 is formed between the second side column 22 and the first side column 12. The second center column 23 of the second core component 2 is connected with the first center column 13 of the first core component 1 in a non-contact manner, that is, the second center column 23 is connected with the first center column 13, and a third air gap AG3 is formed between the second center column 23 and the first center column 13.

The plurality of separation components 31,32,33, i.e., three separation components 31,32,33 in this embodiment, respectively disposed between the two second side columns 21,22 and the two first side columns 11,12, and between the second center column 23 and the first center column 13. Specifically, the separation component 31 is disposed between the second side column 21 and the first side column 11, the separation component 32 is disposed between the second side column 22 and the first side column 12, and the separation component 33 is disposed between the second center column 23 and the first center column 13. Accordingly, by means of insulation and isolation, the induced current paths between the first core component 1 and the second core component 2 are blocked.

In the present disclosure, each separation component 31,32,33 is made of electrically insulating material, for example, but not limited to, insulating plastic, insulating tape, insulating paint, or paper. Any component made of materials that can be used as electrical insulation may be used as the separation component 31,32,33 in the present disclosure. Alternatively, each separation component 31,32,33 is air. Therefore, by the design of the first core component 1 and the second core component 2 being arranged on a bobbin, the two second side columns 21,22 and the two first side columns 11,12 are separated through the air as the separation components 31,32 respectively for electrical insulation, and the second center column 23 and the first center column 13 are separated through the air as the separation component 33 for electrical insulation.

For example, if the high noise source is located on the first core component 1 and the low noise source is located on the second core component 2, by arranging the separation components 31,32,33 between the first core component 1 and the second core component 2 in an insulating manner, the currents flowing through the induced current paths from the first core component 1 to the second core component 2 can be blocked. One the contrary, if the high noise source is located on the second core component 2 and the low noise source is located on the first core component 1, by arranging the separation components 31,32,33 between the first core component 1 and the second core component 2 in an insulating manner, the currents flowing through the induced current paths from the second core component 2 to the first core component 1 can be blocked.

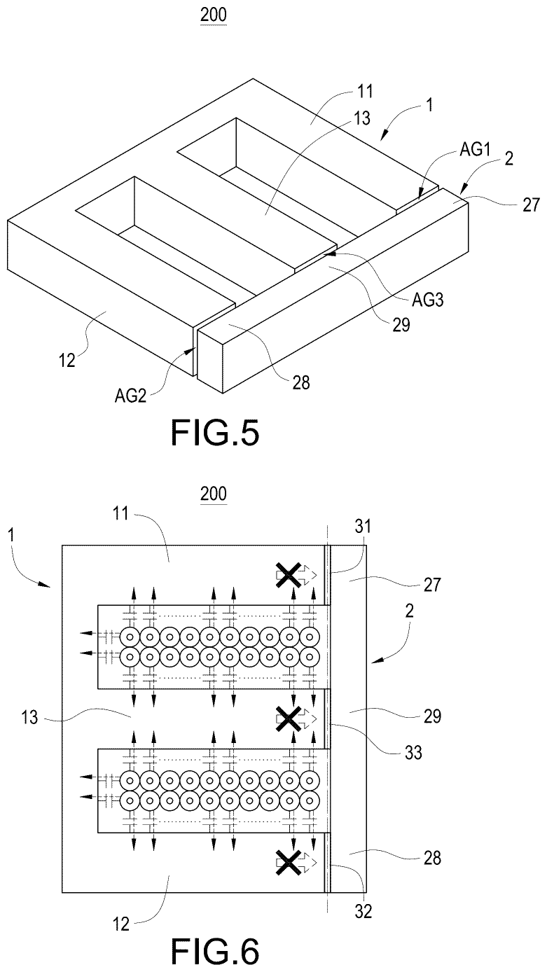

Please refer to FIG. 5 and FIG. 6, which show a schematic perspective diagram of the transformer core according to a second embodiment of the present disclosure and a schematic diagram of blocking induced current paths of the transformer core in FIG. 5 respectively. The transformer core 200 includes a first core component 1, a second core component 2, and a plurality of separation components 31,32,33. In this embodiment, the first core component 1 and the second core component 2 are an E-shaped magnetic core and an I-shaped magnetic core respectively, that is the transformer core 200 is an EI-type core.

The first core component 1 includes two first side columns 11,12 and one first center column 13. The second core component 2 includes two side terminals 27,28 and one center terminal 29. The two side terminals 27,28 of the second core component 2 are connected with the two first side columns 11,12 of the first core component 1 in a non-contact manner. Specifically, the side terminal 27 is connected with the first side column 11 in a non-contact manner, and a first air gap AG1 is formed between the side terminal 27 and the first side column 11. The side terminal 28 is connected with the first side column 12 in a non-contact manner, and a second air gap AG2 is formed between the side terminal 28 and the first side column 12. The center terminal 29 of the second core component 2 is connected with the first center column 13 of the first core component 1 in a non-contact manner, that is, the center terminal 29 is connected with the first center column 13, and a third air gap AG3 is formed between the center terminal 29 and the first center column 13.

The plurality of separation components 31,32,33, i.e., three separation components 31,32,33 in this embodiment, respectively disposed between the two side terminals 27,28 and the two first side columns 11,12, and between the center terminal 29 and the first center column 13. Specifically, the separation component 31 is disposed between the side terminal 27 and the first side column 11, the separation component 32 is disposed between the side terminal 28 and the first side column 12, and the separation component 33 is disposed between the center terminal 29 and the first center column 13. Accordingly, by means of insulation and isolation, the induced current paths between the first core component 1 and the second core component 2 are blocked.

In the present disclosure, each separation component 31,32,33 is made of electrically insulating material, for example, but not limited to, insulating plastic, insulating tape, insulating paint, or paper. Any component made of materials that can be used as electrical insulation may be used as the separation component 31,32,33 in the present disclosure. Alternatively, each separation component 31,32,33 is air. Therefore, by the design of the first core component 1 and the second core component 2 being arranged on a bobbin, the two side terminals 27,28 and the two first side columns 11,12 are separated through the air as the separation components 31,32 respectively for electrical insulation, and the center terminal 29 and the first center column 13 are separated through the air as the separation component 33 for electrical insulation.

For example, if the high noise source is located on the first core component 1 and the low noise source is located on the second core component 2, by arranging the separation components 31,32,33 between the first core component 1 and the second core component 2 in an insulating manner, the currents flowing through the induced current paths from the first core component 1 to the second core component 2 can be blocked. One the contrary, if the high noise source is located on the second core component 2 and the low noise source is located on the first core component 1, by arranging the separation components 31,32,33 between the first core component 1 and the second core component 2 in an insulating manner, the currents flowing through the induced current paths from the second core component 2 to the first core component 1 can be blocked.

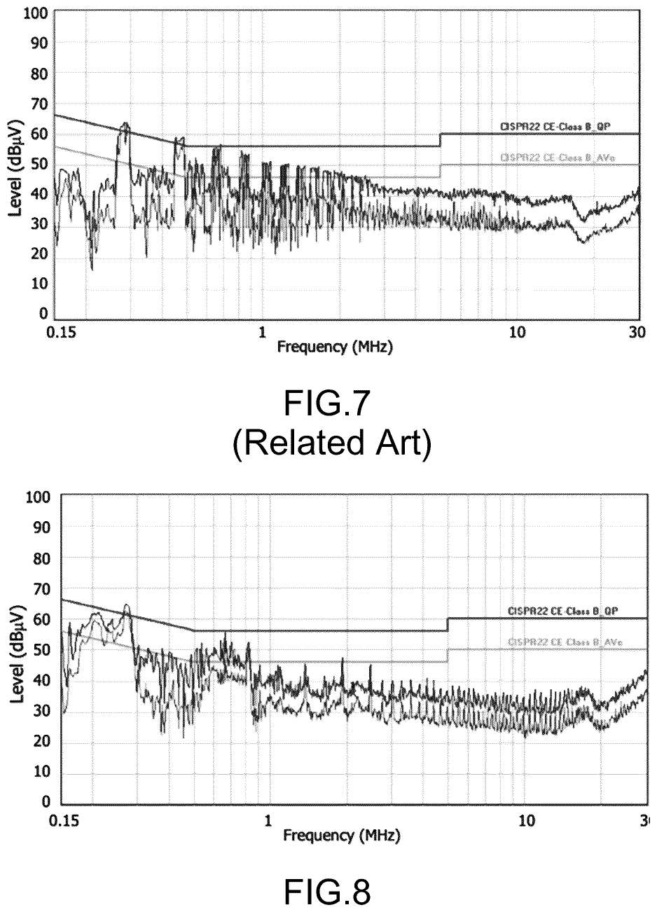

Please refer to FIG. 7 and FIG. 8, which show a waveform diagram of actual verification results of the traditional transformer core and a waveform diagram of actual verification results of the transformer core according to the present disclosure respectively. Both the peak value waveform and the average value waveform in FIG. 8 are better in performance than the peak value waveform and the average value waveform in FIG. 7. Therefore, it can be seen that the transformer core proposed by the present disclosed combined with the use of separation components can provide excellent electrical performance compared with traditional transformer cores.

Accordingly, the present disclosure has the following features: the transformer core is physically divided into at least two parts, and contact surfaces of the magnetic bodies in each divided magnetic body are electrically insulated to ensure that the divided magnetic bodies do not directly contact each other so as to block currents flowing through induced current paths. Furthermore, the present disclosure has the following advantages: 1. the conductor losses caused by induced current, and the common mode current can be reduced; 2. as the common mode noise in the transformer core is reduced, the use of external EMI filters can be reduced, and due to its small size, it contributes to high efficiency and miniaturization design; 3. it does not increase or change the performance or quantity of core raw materials, and therefore it can significantly increase performance within a limited cost.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A transformer core, comprising:
a first core component comprising two first side columns and one first center column,
a second core component comprising two second side columns and one second center column, wherein the two second side columns of the second core component are connected with the two first side columns of the first core component in a non-contact manner, and the second center column of the second core component is connected with the first center column of the first core component in a non-contact manner, and
a plurality of separation components respectively disposed between the two second side columns and the two first side columns, and between the second center column and the first center column so as to block induced current paths between the first core component and the second core component.

2. The transformer core as claimed in claim 1, wherein each separation component is made of electrically insulating material.

3. The transformer core as claimed in claim 2, wherein each separation component is insulating plastic, insulating tape, insulating paint, or paper.

4. The transformer core as claimed in claim 1, wherein each separation component is air.

5. The transformer core as claimed in claim 1, wherein the first core component and the second core component are an E-shaped magnetic core and an E-shaped magnetic core respectively.

6. A transformer core, comprising:
a first core component comprising two first side columns and one first center column,
a second core component comprising two side terminals and one center terminal, wherein the two side terminals of the second core component are connected with the two first side columns of the first core component in a non-contact manner, and the center terminal of the second core component is connected with the first center column of the first core component in a non-contact manner, and
a plurality of separation components respectively disposed between the two side terminals and the two first side columns, and between the center terminal and the first center column so as to block induced current paths between the first core component and the second core component.

7. The transformer core as claimed in claim 6, wherein each separation component is made of electrically insulating material.

8. The transformer core as claimed in claim 7, wherein each separation component is insulating plastic, insulating tape, insulating paint, or paper.

9. The transformer core as claimed in claim 6, wherein each separation component is air.

10. The transformer core as claimed in claim 6, wherein the first core component and the second core component are an E-shaped magnetic core and an I-shaped magnetic core respectively.
